(19) United States
(12) Patent Application Publication
(10) Pub. No.: US 2023/0356725 A1
(43) Pub. Date: Nov. 9, 2023

(54) METHOD FOR CALIBRATING A YAW RATE SENSOR OF A VEHICLE

(71) Applicant: CONTINENTAL AUTOMOTIVE GMBH, Hannover (DE)

(72) Inventors: Mohanad Youssef, Frankfurt am Main (DE); Kai Bretzigheimer, Eschborn (DE)

(73) Assignee: Continental Automotive Technologies GmbH, Hannover (DE)

(21) Appl. No.: 18/042,153

(22) PCT Filed: Aug. 3, 2021
(86) PCT No.: PCT/DE2021/200100

§ 371 Date: Feb. 17, 2023

(30) Foreign Application Priority Data
Aug. 17, 2020 (DE) 10 2020 210 420.4

(51) Int. Cl. B60W 40/10; B60W 60/00

(52) U.S. Cl. CPC B60W 40/10; B60W 60/00; B60W 2520/14; B60W 2420/42; B60W 2556/35

(57) ABSTRACT

A method for calibrating a yaw rate sensor of a vehicle, comprises detecting a yaw rate of the vehicle from measurement data from the yaw rate sensor. A change in yaw angle is ascertained from sensor data from at least one optical surroundings sensor unit, wherein an offset of the yaw rate sensor is ascertained, the offset being ascertained by fusion of the detected yaw rate and the ascertained change in yaw angle. The yaw rate sensor is calibrated according to the ascertained offset.

### CROSS-REFERENCE TO RELATED APPLICATIONS

The present application is a National Stage Application under 35 U.S.C. § 371 of International Patent Application No. PCT/DE2021/200100 filed on Aug. 3, 2021 and claims priority from German Patent Application No. 10 2020 210 420.4 filed on Aug. 17, 2020, in the German Patent and Trademark Office, the disclosures of which are herein incorporated by reference in their entireties.

### TECHNICAL FIELD

The invention relates to a method and a device for calibrating a yaw rate sensor of a vehicle. The invention also relates to a vehicle having such a device and to a computer program product.

### BACKGROUND

Modern motor vehicles such as passenger cars, trucks, motorized two-wheelers or other means of transport known from the prior art are often equipped with driving dynamics control systems such as ESC (Electronic Stability Control) that can influence the driving behavior of a motor vehicle in a targeted manner. In addition, a large number of driver assistance systems such as park assist, lane assist, adaptive cruise control or queue assist are known that can be used to guide the motor vehicle in a semi-automated or fully automated manner. For a number of driver assistance systems, it is important to know the exact vehicle orientation of the vehicle. This is a crucial factor in being able to guide the vehicle on the planned path, or along a planned trajectory, without collisions.

The vehicle orientation is estimated, for example, by means of a yaw rate sensor of the stability control system (ESC). However, a disadvantage of the yaw rate sensor is its variable distortion and scale characteristics, which cause sensor drift. The yaw rate signal, in particular the quality thereof, thus influences the determination of the vehicle orientation and consequently the operation of a driver assistance system when guiding the motor vehicle along a planned trajectory.

Against this background, the yaw rate sensor is usually calibrated, thus ascertaining and subsequently compensating for an offset. The offset describes a deviation of the yaw rate sensor and thus an amount by which the yaw rate detected by means of the yaw rate sensor deviates from an actual yaw rate of the vehicle. By compensating for the detected yaw rate according to the offset value, it is possible to at least reduce or eliminate the aforesaid deviation in the yaw rate detected by means of the yaw rate sensor from the actual yaw rate of the vehicle, so that the yaw rate detected by means of the yaw rate sensor at least closely matches the actual yaw rate. This reduction or elimination of the deviation is referred to as offset compensation.

A known calibration method is, for example, to average measured values from the yaw rate sensor while the vehicle is at a standstill in order to ensure that the vehicle is stationary and that a detected offset can therefore actually be attributed to a distorted measurement signal from the yaw rate sensor. The problem with averaging the measured values from the yaw rate sensor while the vehicle is at a standstill is that a learnt offset is not updated during vehicle movement and therefore a changing offset, as may occur due to non-linearity errors when the yaw rate sensor is turning, for example, is not taken into account. Consequently, the detection of the offset needs to be regularly updated during movement in order to improve the accuracy of the estimated vehicle orientation.

Another approach for calibrating the yaw rate sensor while the vehicle is moving is to combine kinematic and dynamic vehicle models. However, the accuracy of the ascertained yaw rate depends on the accuracy of other vehicle parameters that are used in the vehicle models, such as measurement data from the steering wheel angle sensor and the wheel speed sensors of the motor vehicle. If there is an offset between the steering wheel angle and the actual wheel angles of the front axle, this results in a significant deterioration in the accuracy of the yaw rate calculated from the vehicle model. Furthermore, the measurement data from the wheel speed sensor can be used in a meaningful way only upward of a certain minimum velocity. Particularly at low maneuvering velocities, as is usually the case with parking maneuvers, the measurement data relating to wheel speed therefore have a negative impact on the accuracy for determining the yaw rate.

### SUMMARY

A method for calibrating a yaw rate sensor of a vehicle, in particular during vehicle movement, is proposed. A yaw rate of the vehicle is detected from measurement data from the yaw rate sensor. The detection of the yaw rate makes it possible for example to determine the vehicle orientation.

Furthermore, a change in yaw angle, and thus a change in the vehicle orientation, is ascertained from sensor data from at least one optical surroundings sensor unit. The changed vehicle orientation is intended to be understood to mean for example the vehicle position that has changed over time, e.g. between two sampling times. In other words, a change in yaw angle is detected in particular on the basis of a visual odometry. For example, the change in yaw angle is determined by detecting a relative position of the vehicle in relation to at least one object point arranged in the surroundings of the vehicle and sensing a relative change in position during a vehicle movement.

In an embodiment, the optical surroundings sensor unit is at least one vehicle camera, specifically at least one front camera of the motor vehicle. In another embodiment, the optical surroundings sensor unit comprises at least one front and/or rear camera and at least two side cameras. Camera data does not contain an offset, and so determination of the offset is possible by way of a comparison against the measurement data from the yaw rate sensor.

For example, a respective image position of at least one image feature, e.g. an object point, is ascertained in successive frames of the image sequence generated by the at least one vehicle camera. Furthermore, the change in yaw angle is ascertained on the basis of the change in the image position of the at least one image feature between the recording times of the frames.

An offset of the yaw rate sensor is ascertained. The offset is for example a deviation of the yaw rate sensor between the yaw rate detected by means of the yaw rate sensor and an actual yaw rate of the vehicle. Fusion of the detected yaw rate of the yaw rate sensor and the ascertained change in yaw angle are used to ascertain the offset. The optical surroundings sensor unit is thus included for example as a further source for calibrating the yaw rate measured by the yaw rate sensor. The fusion may be used to ascertain a difference between the vehicle orientations ascertained independently of one another.

The yaw rate sensor is calibrated according to the ascertained offset. For example, the yaw rate of the yaw rate sensor is corrected according to the ascertained offset. A change in orientation of the vehicle may be determined on the basis of the corrected yaw rate and by fusion of the corrected yaw rate and the visual odometry. For example, the determined change in orientation is taken as a basis for carrying out semi- or fully automated guidance of the motor vehicle along an ascertained ego trajectory, for example a downstream driver assistance function, such as e.g. a park assist or lane assist.

For example, the method improves the determination of the yaw rate offset of the measured gyroscope speed signals during vehicle movement. Consequently, a drift caused by the yaw rate sensor can be prevented or at least reduced. This achieves determination of the vehicle orientation of the vehicle and consequently guidance of the vehicle along a planned trajectory on the basis of the ascertained vehicle orientation.

According to a development, the change in orientation of the vehicle is determined by fusioning the detected yaw rate and ascertained change in yaw angle by means of a Kalman filter. In other words, the yaw rate and the change in yaw angle are supplied to further processing in a Kalman filter in order to determine the offset. The Kalman filter is based for example on a process model for the iterative estimation of system parameters on the basis of erroneous observations.

The principle of the Kalman filter consists for example in filtering for the present value of a state vector and making a prediction for the next sampling time. Against this background, the Kalman filter thus includes for example a prediction step and a correction step, the prediction step comprising ascertaining the expected change in yaw angle and the expected yaw rate and the correction step receiving the detected yaw rate and the change in yaw angle ascertained between two camera images. Thus, the prediction step comprises no processing of measurement data, rather only performing accumulation based on a yaw acceleration of the vehicle.

The detection of the yaw rate may be performed periodically with a first period duration and the ascertainment of the change in yaw angle is performed periodically with a second period duration, which is different from the first period duration. For example, the fusion of the yaw rate and the change in yaw angle is performed periodically with a fusion period duration. The ascertainment of the change in yaw angle, for example from camera data from the vehicle camera, is often predefined using the frame rate of the camera. As a result of the fusion that is performed, it is not necessary to adjust the ascertainment of the yaw rate to suit this frame rate.

In an embodiment, the fusion comprises checking whether a new change in yaw angle between the captured camera images has been ascertained since the preceding fusion and, if this is not the case, no correction step being performed or the correction step receiving the last detected change in yaw angle with reduced weighting. In other words, after the prediction step, a decision is made in which it is determined whether the correction step should also be performed. This may involve checking whether the change in yaw angle has been updated since the last update, that is to say execution of the Kalman filter. This prevents an outdated change in yaw angle from being taken into account again, which could cause measurement artifacts. Instead, only current measurement data are used to calibrate the yaw rate sensor and consequently to determine the vehicle orientation.

The optical surroundings sensor unit as the vehicle camera can have camera images of insufficient quality depending on the situation, for example due to darkness or adverse weather conditions, which could result in at least inaccurate ascertainment of the change in yaw angle. Against this, the correction step may comprise ascertaining a deviation between at least two, for example at least three, individual measured values from the yaw rate sensor that contain an offset and the offset-free measured values from the optical surroundings sensor unit. Furthermore, the ascertained deviation may be received with reduced weighting. For example, the ascertained deviation is multiplied by a weighting of approximately 0.01. In particular, the result is used when ascertaining the offset. The weighting may be in a setting parameter for the learning speed relating to the offset.

Thus, for example, instead of the individual data, only the associated mean values are supplied to the Kalman filter. Ascertaining the offset on the basis of multiple measured values over a certain period of time ensures that the offset is not ascertained on the basis of an isolated measurement error, e.g. on the basis of camera images of insufficient quality. Furthermore, taking multiple successive measured values into account allows outliers to be identified and mitigated as appropriate by means of a weighting in the Kalman filter.

For example, an offset compensation takes place, thus a correction of the detected yaw rate containing the offset. Furthermore, a change in orientation of the vehicle may be determined by means of a fusion of the corrected yaw rate and the measurement data from the at least one vehicle camera. Thus, the change in orientation may be ascertained by means of visual odometry. This is supposed to prevent the vehicle orientations ascertained on the yaw rate sensor and the at least one vehicle camera from drifting excessively. For example, the determined change in orientation is taken as a basis for carrying out semi- or fully automated guidance of the vehicle along an ascertained ego trajectory.

A further subject relates to a computer program product for calibrating the yaw rate sensor of the vehicle, wherein the computer program product comprises instructions that, when executed on a control unit or a computer of the vehicle, carry out the method according to the preceding description.

A further subject relates to a device for calibrating a yaw rate sensor of a vehicle, wherein the device has a processing unit configured to carry out a method according to the preceding description. It should be noted that the processing unit can be an electronic circuit, a switching circuit, an arithmetic and logic unit, a control apparatus, a processor or a control unit. Furthermore, the processing unit can have a storage unit that stores the data required and/or generated by the processing unit.

Another subject relates to a vehicle having such a control device.

### BRIEF DESCRIPTION OF THE DRAWINGS

The invention is described in more detail below with reference to expedient exemplary embodiments. In this case:

FIG. 1 shows a schematic representation of a vehicle with a device for calibrating a yaw rate sensor;

FIG. 2 shows a schematic representation of a Kalman filter;

FIG. 3 shows a timeline of the yaw angle with measurement data;

FIG. 4 uses a graph to show periodic fusion of an ascertained yaw rate and change in yaw angle.

### DETAILED DESCRIPTION

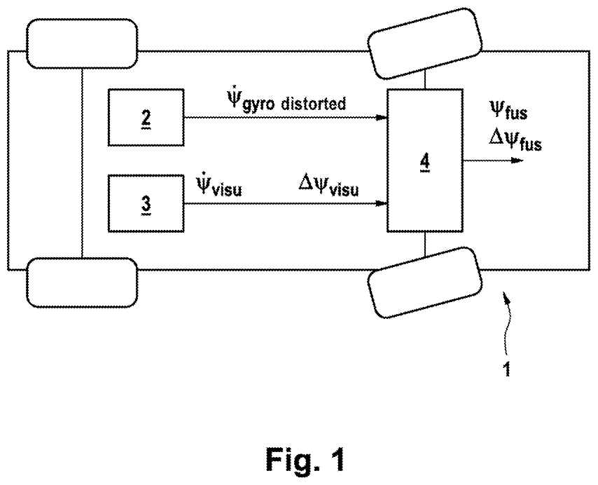

Reference numeral 1 in FIG. 1 denotes a vehicle comprising a device for calibrating a yaw rate sensor 2 for the vehicle 1. The calibrated yaw rate sensor 2 is taken as a basis for performing for example an offset compensation for the measured yaw rate ψgyro and a determination of the vehicle orientation relative to the ascertained ego trajectory, the determined vehicle orientation being taken as a basis for carrying out semi- or fully automated guidance of the vehicle 1 along the ascertained ego trajectory. As a result of the offset compensation, the measured yaw rate ψgyro is corrected in such a way that it at least closely matches the actual yaw rate.

The yaw rate sensor 2 of the vehicle 1 is designed to provide measurement data for a yaw rate ψgyro of the vehicle 1. Furthermore, the vehicle 1 comprises at least one vehicle camera 3 that captures an image sequence. In particular, the successive frames of the image sequence are used to ascertain a yaw rate ψvisu and a change in yaw angle Δψvisu of the vehicle 1. A new orientation ψ of the vehicle 1 is determinable as a result of a change Δψvisu. For example, the vehicle camera 3 comprises an evaluation unit designed to ascertain the change in yaw angle Δψvisu of the vehicle 1 from the image sequence. The change in yaw angle Δψvisu is determined for example by first combining the frames to produce an overall image and taking the latter as a basis for performing an evaluation.

The vehicle 1 comprises e.g. a processing unit 4 designed to ascertain an offset ψgyro offset of the yaw rate sensor 2. The detected yaw rate ψgyro and change in yaw angle Δψvisu are e.g. transferred to the processing unit 4, the processing unit 4 being designed to ascertain the offset and to fusion the detected yaw rate ψgyro and the change in yaw angle Δψvisu. The measured yaw rate ψgyro is thus taken as a basis for ascertaining a state variable ψfus and consequently a corrected yaw rate that at least closely matches the actual yaw rate of the vehicle. Compensating for the offset allows determination of the vehicle orientation in a vehicle environment model and, based thereon, the semi- or fully automated guidance of the vehicle 1 along a planned ego trajectory.

The fusion of the yaw rate ψgyro in a Kalman filter 5 takes place on the basis of the yaw rate sensor 2 and the change in yaw angle Δψvisu on the basis of the at least one vehicle camera 3. Fusion of the distorted measurement signal from the yaw rate sensor 2 and the yaw rate ψvisu calculated by means of visual odometry by way of a fusion frame as the Kalman filter 5 allows the offset of the yaw rate sensor 2 to be ascertained during vehicle movement.

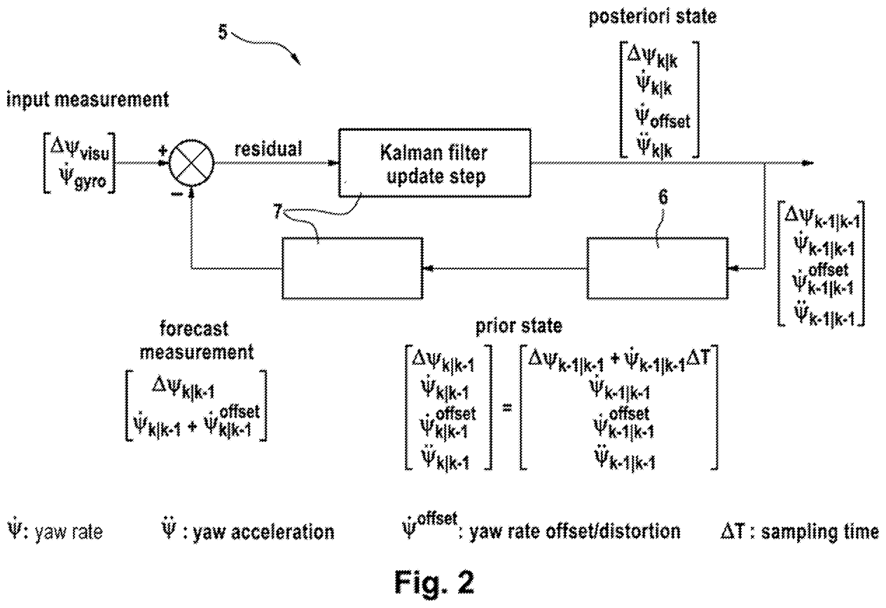

FIG. 2 schematically shows a detailed view of the Kalman filter 5. K stands for the number of sampling times, thus for example for the number of previous calculation steps. The Kalman filter 5 has a prediction step 6 and a correction step 7, in order to ascertain from the detected yaw rate ψ_{gyro} and change in yaw angle Δψᵥᵢₛᵤ a fusioned yaw rate ψ_{gyro fus} and a fusioned change in yaw angle Δψ_{visu fus} and to output these as output values. The Kalman filter 5 is called e.g. with a fusion period duration t_{fus}=10 ms in order to be able to output an output value every 10 ms to a downstream vehicle function such as e.g. a lane assist.

The yaw rate ψ_{gyro} is ascertained from the measurement data from the yaw rate sensor 2, updated with an update time t_{gyro} of the yaw rate sensor 2 and supplied to the Kalman filter 5. The change in yaw angle Δψvisu is ascertained from the measurement data from the at least one vehicle camera 3 and updated with an update time t_{cam}. Purely by way of illustration, the update time t_{gyro} of the yaw rate sensor is 10 ms and the update time t_{cam} of the vehicle camera is 33 ms, which results from the frame rate of the at least one vehicle camera 3 of 30 frames/s.

After the prediction step 14, a decision is made in which it is determined whether the correction step 7 should also be performed. This involves checking whether the change in yaw angle Δψvisu has been updated since the last update, that is to say during execution of the Kalman filter 5.

The yaw rate sensor 2 and the at least one vehicle camera 3 transfer the measurement data at a different update rate. As already mentioned hereinabove, the update rate for the camera images is 30 frames/s and that for the measurement data from the yaw rate sensor is 20 ms. The fusion time for the data is 10 ms, for example. While the change in orientation between two different updates of the fusion is needed for further processing, the visual odometry provides the change in orientation within 33 ms. Against this background, the state Δψ was introduced in the Kalman filter 5, said state representing the fusioned change in yaw angle Δψvisu from an update of the last update of the visual odometry to the present time. This means that this state is set to zero after each update. For a new update of the visual odometry, this state contains the estimated change in yaw angle for 30 ms or for 40 ms. However, the visual odometry always provides the change in yaw angle Δψvisu at update rates of 33 ms. For this reason, e.g. the change in yaw angle Δψvisu is extrapolated for 7 ms or reduced for 3 ms. The change in yaw angle Δψvisu is then ready for fusioning.

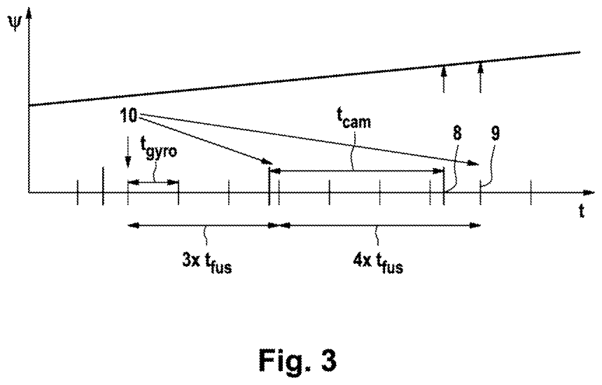

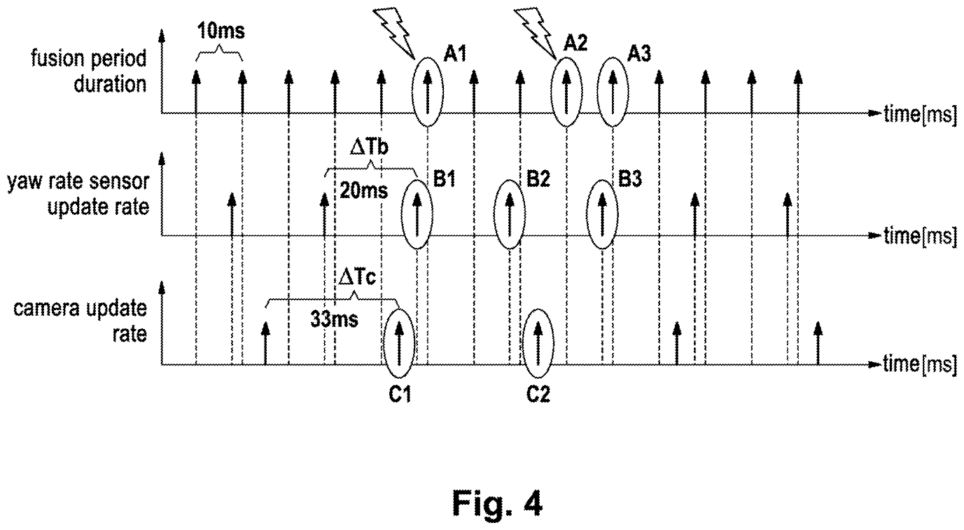

The update of the yaw rate ψ_{gyro} and the change in yaw angle Δψᵥᵢₛᵤ is illustrated in FIGS. 3 and 4. FIG. 3 shows a time scale with a vehicle orientation ψ and the various update times 6 of the yaw rate ψ_{gyro} and the update times 7 of the change in yaw angle Δψᵥᵢₛᵤ. Since the fusion period duration t_{fus} is identical to the first update time t_{gyro}, the Kalman filter 5 is called for each new yaw rate ψ_{gyro} and fusion of the data is thus performed. Since the change in yaw angle Δψvisu is updated with an update time of t_{cam}=33 ms, the update times 8 are offset from the update times 9. It can be seen that whenever the Kalman filter 5 is called after 30 ms or 40 ms, a new change in yaw angle Δψᵥᵢₛᵤ is also present. These times are identified by 10 in FIG. 3, since this embodiment of the Kalman filter 5 also involves the correction step 7 being performed.

As an addition to FIG. 3, FIG. 4 is intended to show the fusion of the input signals of the yaw rate sensor 2 and the vehicle camera 3 in the Kalman filter 5. As such, the top graph shows the fusion period duration t_{fus} of 10 ms, the middle graph shows the update rate of the yaw rate sensor 2 at 20 ms and the bottom graph shows the update rate of the at least one vehicle camera 3 at 33 ms.

According to a first exemplary embodiment, a fusion cycle comprises fusion of an updated change in yaw angle Δψᵥᵢₛᵤ of the at least one vehicle camera 3, which was detected at time C1, and an updated yaw rate of the yaw rate sensor 2, which was detected at time B1, at time A1.

According to a second exemplary embodiment, a fusion cycle comprises detecting an updated change in yaw rate Δψᵥᵢₛᵤ of the at least one vehicle camera at time C2, no updated yaw rate ψ_{gyro} of the yaw rate sensor 2 having been detected since the last fusion cycle. In such a case, the last detected yaw rate ψ_{gyro} of yaw rate sensor 2 is extrapolated at time B2 and finally fusioned with the change in yaw angle Δψᵥᵢₛᵤ detected at time C2.

According to a third exemplary embodiment, a fusion cycle comprises detecting an updated yaw rate ψ_{gyro} of the yaw rate sensor 2 at time B3, no updated change in yaw angle Δψᵥᵢₛᵤ of the vehicle camera 3 having been detected since the last fusion cycle. In such a case, no update of the fusion state is performed.

The embodiments it possible to learn the offset of the yaw rate sensor 2 during vehicle movement by fusion of the yaw rate ψvisu calculated and output by means of the visual odometry with the yaw rate ψ_{gyro} measured by the yaw rate sensor 2. The method described enables the vehicle orientation to be determined by fusion of the data from the yaw rate sensor 2 and the at least one vehicle camera 3.

1. A method for calibrating a yaw rate sensor of a vehicle comprising:
detecting a yaw rate of the vehicle from measurement data from the yaw rate sensor,
ascertaining a change in yaw angle from sensor data from at least one optical surroundings sensor unit,
ascertaining an offset of the yaw rate sensor by fusion of the detected yaw rate and the ascertained change in yaw angle, and
calibrating the yaw rate sensor according to the ascertained offset.

2. The method as claimed in claim 1, further comprising determining a change in orientation of the vehicle by fusion of the ascertained yaw rate and the ascertained change in yaw angle with a Kalman filter.

3. The method as claimed in claim 1, further comprising ascertaining a fusioned yaw rate and a fusioned change in yaw angle from the fusion of the detected yaw rate and the ascertained change in yaw angle.

4. The method as claimed in claim 1, wherein the detecting the yaw rate is performed periodically with a first period duration and the ascertaining the change in yaw angle is performed periodically with a second period duration, which is different from the first period duration.

5. The method as claimed in claim 1, wherein the fusion of the yaw rate and the change in yaw angle is performed periodically with a fusion period duration and the ascertaining the offset further comprises ascertaining from a plurality of periodically and successively ascertained measured values relating to the yaw rate and change in yaw angle.

6. The method as claimed in claim 1, further comprising ascertaining a respective image position of at least one image feature in successive frames of an image sequence generated by at least one vehicle camera of the at least one optical surroundings sensor unit, and ascertaining the change in yaw angle on the basis of the change in the image position of the at least one image feature between recording times of the frames.

7. The method as claimed in claim 1, wherein an offset compensation takes place at the detected yaw rate.

8. A computer program for calibrating a yaw rate sensor of a vehicle, wherein the computer program product comprises instructions comprising:
detecting a yaw rate of the vehicle from measurement data from the yaw rate sensor,
ascertaining a change in yaw angle from sensor data from at least one optical surroundings sensor unit,
ascertaining an offset of the yaw rate sensor by fusion of the detected yaw rate and the ascertained change in yaw angle, and
calibrating the yaw rate sensor is calibrated according to the ascertained offset.

9. A device for calibrating a yaw rate sensor of a vehicle, wherein the device has a processing unit with instructions comprising:
detecting a yaw rate of the vehicle from measurement data from the yaw rate sensor,
ascertaining a change in yaw angle from sensor data from at least one optical surroundings sensor unit,
ascertaining an offset of the yaw rate sensor by fusion of the detected yaw rate and the ascertained change in yaw angle, and
calibrating the yaw rate sensor is calibrated according to the ascertained offset.

10. The device as claimed in claim 9 wherein the device is in a vehicle.

11. The method of claim 1, further comprising determining the change in orientation of the vehicle based on fusion of a corrected yaw rate and a visual odometry.

12. The method of claim 11, further comprising carrying out one of semi-automated and fully automated guidance of the vehicle along an ascertained ego trajectory based on the determined change in orientation.
